(19) United States
(12) Patent Application Publication
(10) Pub. No.: US 2015/0223594 A1
(43) Pub. Date: Aug. 13, 2015

(54) TOOTHBRUSH FOR HUMAN OR NON-HUMAN SUBJECTS

(71) Applicant: Vahe Ohanessian, Tujunga, CA (US)

(72) Inventor: Vahe Ohanessian, Tujunga, CA (US)

(21) Appl. No.: 14/618,735

(22) Filed: Feb. 10, 2015

Related U.S. Application Data
(60) Provisional application No. 61/939,046, filed on Feb. 12, 2014.

(51) Int. Cl. A46B 9/04; A46B 5/00; A46B 11/00; A61D 5/00

(52) U.S. Cl. CPC A46B 9/045; A61D 5/00; A46B 5/0016; A46B 11/0062; A46B 11/0041

(57) ABSTRACT

The present invention recognizes that there exists a need for toothbrushes for human or non-human subjects, such as but not limited to animals, and methods of use. The present invention generally pertains to toothbrushes for animals and methods of use thereof to address this need. A first aspect of the present invention is an oral care device for cleaning a human or non-human subject's teeth including a body portion and a bristle-including portion. A second aspect of the present invention is an oral care device for cleaning a human or non-human subject's teeth including a body portion. A third aspect of the present invention is an edible or substantially edible oral care device for cleaning a human or non-human subject's teeth

The present application claims benefit of priority to U.S. Provisional Patent Application Ser. No. 61/939,046, filed on Feb. 12, 2014, which is incorporated by reference herein in its entirety.

### TECHNICAL FIELD

The present invention relates to a toothbrush for a human or non-human subject, such as but not limited to an animal, e.g., a pet such as a dog or a cat, and in particular to a toothbrush configured to effectively clean a pet animal's teeth by utilizing the animal's propensity to bite down on objects placed into their mouths.

### BACKGROUND

Animals require dental cleaning and care regularly to prevent tooth decay and plaque and calculus buildup. To achieve this, many traditional tooth cleaning devices are built to resemble traditional toothbrushes for humans with bristles attached to one side of an elongated handle, the grouping of bristles having a collective flat brushing surface. The traditional pet toothbrush is configured to be brushed against the animal's tooth surface in a back and forth or circular motion, much like humans brush their own teeth. This conventional pet brush construction does not take into account differences between the structure of human teeth and animal teeth. Moreover, because animals are likely to bite when their teeth are being brushed, it is difficult to properly brush an animal's teeth without first restraining it or placing it under anesthesia. Both of these options are undesirable for most pet owners.

### BRIEF DESCRIPTION OF THE DRAWINGS

FIG. 1A and FIG. 1B each depict but one aspect of the present invention. In particular FIG. 1A depicts a three-quarter angle gross view of at least one embodiment of the present invention; and in particular FIG. 1B depicts a three-quarter angle of a close-up of at least one embodiment of the present invention.

FIG. 2A, FIG. 2B, and FIG. 2C each depict but one aspect of the present invention, in particular depict a profile of at least one embodiment of separate aspects of the present invention.

FIG. 3A and FIG. 3B each depict but one aspect of the present invention, in particular FIG. 3A depicts a cross-sectional view of at least one embodiment of the present invention; and in particular FIG. 3B depicts a cross-sectional view of at least a second embodiment of the present invention.

FIG. 4A and FIG. 4B each depict but one aspect of the present invention, in particular FIG. 4A depicts a cross-sectional view of at least one embodiment of the present invention engaging at least one oral surface of a non-human subject; and FIG. 4B depicts a cross-sectional view of at least a second embodiment of the present invention engaging at least one oral surface of a non-human subject.

FIG. 5A, FIG. 5B, and FIG. 5C each depict but one aspect of the present invention, in particular a profile view of at least one embodiment of the present invention being at least in part different in size relative to at least one second embodiment of the present invention. The device in FIG. 5A being larger than in FIG. 5B, being larger than in FIG. 5C.

FIG. 6A and FIG. 6B each depict but one aspect of the present invention, in particular at least one embodiment of the present invention having two toothbrush heads attached on either end of the elongated toothbrush member.

### SUMMARY

The present invention recognizes that there exists a need for toothbrushes for human or non-human subjects, such as but not limited to animals, and methods of use. The present invention generally pertains to toothbrushes for humans or non-human animals and methods of use thereof to address this need.

A first aspect of the present invention is an oral care device for cleaning a human or non-human subject's teeth including a body portion and a bristle-including portion.

A second aspect of the present invention is an oral care device for cleaning a human or non-human subject's teeth including a body portion.

A third aspect of the present invention is an edible or substantially edible oral care device for cleaning a human or non-human subject's teeth.

### DETAILED DESCRIPTION OF THE INVENTION

### Definitions

Unless defined otherwise, all technical and scientific terms used herein have the same meaning as commonly understood by one of ordinary skill in the art to which this invention belongs. Generally, the nomenclature used herein and the procedures and methods used as described below are well known and commonly employed in the relevant art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

Other technical terms used herein have their ordinary meaning in the art that they are used, as exemplified by, but not limited to, a variety of technical dictionaries.

### Introduction

The present invention recognizes that there exists a need for toothbrushes for human or non-human subjects, such as but not limited to animals, and methods of use. The present invention generally pertains to toothbrushes for animals and methods of use thereof to address this need.

As a non-limiting introduction to the breath of the present invention, the present invention includes several general and useful aspects, including but not limited to:
1) an oral care device for cleaning a human or non-human subject's teeth including a body portion and a bristle-including portion;
2) an oral care device for cleaning a human or non-human subject's teeth including a body portion; and
3) an edible or substantially edible oral care device for cleaning human or non-human subject's teeth.

These aspects of the present invention, as well as others described herein, can be achieved by using the methods, articles of manufacture and compositions of matter described herein. To gain a full appreciation of the scope of the present invention, it will be further recognized that various aspects of the present invention can be combined to make desirable embodiments of the present invention.

I. An Oral Care Device for Cleaning a Human or Non-Human Subject's Teeth Including a Body Portion and a Bristle Including Portion

The present invention includes an oral care device for cleaning human or non-human subject's teeth, including: a) at least one body portion; and b) at least one bristle including portion; wherein the at least one body portion and the at least one bristle including portion are operably engaged to provide physical contact of the oral care device to the interior surfaces of a human or non-human subject's oral cavity when in use.

In addition, the at least one body allows an operator to grasp the at least one body and operably engage the interior surfaces of a human or non-human subject's oral cavity

In addition, the at least one body and at least one bristle including portion of the oral care device can be motorized. Preferably, the at least one body and at least one bristle including portion can provide physical contact of the oral care device to the interior surfaces of a human or non-human subject's oral cavity using at least in part the activity of the motor of the oral care device of the present invention

Furthermore, the at least one bristle including portion includes a plurality of flexibly resilient bristles extending radially outward from the bristle including portion and covering all or substantially all surfaces of the bristle including portion.

In the present invention, the at least one bristle including portion can include a plurality of flexibly resilient bristles can have a bristle density as is known in the art. Preferably, the bristle density is between about 1 and about 500 bristles per square millimeter, more preferably between about 2 and about 400, more preferable between about 3 and 300, more preferably between about 4 and 200, more preferably between about 5 and 100, more preferably between about 6 and 90. In a preferred embodiment, the at least one bristle including portion includes a plurality of flexibly resilient bristles can have a bristle density between about 4 and about 30 bristles per square millimeter. More preferably, the at least one bristle including portion includes a plurality of flexibly resilient bristles can have a bristle density such as toothbrushes or other brushes as known in the art for density of bristles.

In the present invention at least one bristle of the at least one bristle including portion can be thin, thick, can have a diameter as is known in the art, or a combination thereof, in at least one portion of at least one bristle of the at least one bristle including portion. Preferably, the diameter of the at least one bristle of the at least one bristle including portion is about 1 and about 50 millimeters, more preferably about 2 and about 45, more preferably about 3 and about 40, more preferably about 4 and about 35. In a preferred embodiment, the diameter of the at least one bristle of the at least one bristle including portion can be about 10 and about 30 millimeters.

In the present invention at least one bristle of the at least one bristle including portion can be of any appropriate shape, such as but not limited to flat, narrow, rounded, polygonal, flat and wide, or a combination thereof, in at least one portion of at least one bristle of the at least one bristle including portion. Preferably, the shape of the at least one bristle of the at least one bristle including portion is at least in part flat and wide, like the shape of a wiper-blade.

In the present invention at least one bristle of the at least one bristle including portion can be relatively as to each other and as known in the art short in length, of medium length, long in length, or a combination thereof in at least one portion of at least one bristle of the at least one bristle including portion. All or substantially all of the bristles can be of the substantially the same, same or similar length. Preferably, the length of the at least one bristle of the at least one bristle including portion has a length of about 1 and about 100 millimeters, more preferably about 2 and about 90 millimeters, more preferably about 3 and about 80 millimeters, more preferably about 4 and about 70 millimeters, more preferably 5 and about 60 millimeters, more preferably 7 and about 50 millimeters. In a preferred embodiment, the length of the at least one bristle of the at least one bristle including portion is about 20 and about 50 millimeters in length. More preferably, the length of the at least one bristle of the at least one bristle including portion is about 25 and about 35 millimeters in length.

In one embodiment, at least one bristle of the bristle including portion includes at least one main bristle and at least one terminating end portion.

In addition, the at least one terminating end portion is angled transverse, perpendicular or at varying angles to the main bristle.

In the present invention, the at least one main bristle of the at least one bristle including portion can be inserted at a minimum angle of about 1 and about 180 degrees, relative to its insertion plane, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one main bristle of the at least one bristle including portion can be inserted at an angle between about 45 and about 90 degrees.

In the present invention, the at least one terminating end portion of the at least one bristle including portion can have a minimum angle of about 1 and about 180 degrees, relative to the at least one main bristle of the at least one bristle including portion, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one terminating end portion of the at least one bristle including portion can be inserted at an angle between about 45 and about 90 degrees, relative to the at least one main bristle of the at least one bristle including portion.

Furthermore, the at least one terminating end portion of at least one bristle is substantially perpendicular to the main bristle.

In another embodiment, the at least one bristle including portion is substantially hollow such that it is capable of housing an oral agent.

In the present invention, the at least one bristle-containing portion is capable of housing at least one oral agent that is ingestible. The at least one oral agent can be, but is not limited to, for example toothpaste, enzymatic oral care solutions, oral sprays, oral gels, or a combination thereof.

In addition, the at least one bristle including portion is at least in part prefilled, refillable, or a combination thereof, with at least one oral agent.

In the present invention, the at least one bristle including portion can be at least in part prefilled, refillable, or a combination thereof with at least one oral agent for the purposes of fighting or preventing cavities, gingivitis, freshening breath, delivering medication, or a combination thereof.

II. An Oral Care Device for Cleaning a Human or Non-Human Subject's Teeth Including a Bristle Including Portion

The present invention includes an oral care device for cleaning a human or nonhuman subject's teeth, including: at least one bristle including portion; wherein the at least one bristle portion is or is substantially the body of said oral care device.

In addition, the bristle including portion includes a plurality of flexibly resilient bristles extending radially outward from the bristle including portion and covering all or substantially all surfaces of the bristle including portion.

In the present invention, the at least one bristle including portion can include a plurality of flexibly resilient bristles can have a bristle density as is known in the art. Preferably, the bristle density is between about 1 and about 500 bristles per square millimeter, more preferably between about 2 and about 400, more preferable between about 3 and 300, more preferably between about 4 and 200, more preferably between about 5 and 100, more preferably between about 6 and 90. In a preferred embodiment, the at least one bristle including portion includes a plurality of flexibly resilient bristles can have a bristle density between about 4 and about 30 bristles per square millimeter. More preferably, the at least one bristle including portion includes a plurality of flexibly resilient bristles can have a bristle density such as toothbrushes or other brushes as known in the art for density of bristles.

Furthermore, the at least one bristle of the bristle including portion includes a main bristle and at least one terminating end portion.

In the present invention at least one bristle of the at least one bristle including portion can be thin, thick, can have a diameter as is known in the art, or a combination thereof, in at least one portion of at least one bristle of the at least one bristle including portion. Preferably, the diameter of the at least one bristle of the at least one bristle including portion is about 1 and about 50 millimeters, more preferably about 2 and about 45, more preferably about 3 and about 40, more preferably about 4 and about 35. In a preferred embodiment, the diameter of the at least one bristle of the at least one bristle including portion can be about 10 and about 30 millimeters.

In the present invention at least one bristle of the at least one bristle including portion can be flat, narrow, rounded, polygonal, flat and wide, or a combination thereof, in at least one portion of at least one bristle of the at least one bristle including portion. Preferably, the shape of the at least one bristle of the at least one bristle including portion is at least in part flat and wide, like the shape of a wiper-blade.

In the present invention at least one bristle of the at least one bristle including portion can be relatively as to each other and as known in the art short in length, of medium length, long in length, or a combination thereof in at least one portion of at least one bristle of the at least one bristle including portion. All or substantially all of the bristles can be of the substantially the same, same or similar length. Preferably, the length of the at least one bristle of the at least one bristle including portion has a length of about 1 and about 100 millimeters, more preferably about 2 and about 90 millimeters, more preferably about 3 and about 80 millimeters, more preferably about 4 and about 70 millimeters, more preferably 5 and about 60 millimeters, more preferably 7 and about 50 millimeters. In a preferred embodiment, the length of the at least one bristle of the at least one bristle including portion is about 20 and about 50 millimeters in length. More preferably, the length of the at least one bristle of the at least one bristle including portion is about 25 and about 35 millimeters in length.

In another embodiment, the at least one terminating end portion is angled transverse, perpendicular or at varying angles to the main bristle.

In addition, the at least one terminating end portion of one or more bristles is substantially perpendicular to said main bristle.

In the present invention, the at least one main bristle of the at least one bristle including portion can be inserted at a minimum angle of about 1 and about 180 degrees, relative to its insertion plane, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one main bristle of the at least one bristle including portion can be inserted at an angle between about 45 and about 90 degrees.

In the present invention, the at least one terminating end portion of the at least one bristle including portion can have a minimum angle of about 1 and about 180 degrees, relative to the at least one main bristle of the at least one bristle including portion, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one terminating end portion of the at least one bristle including portion can be inserted at an angle between about 45 and about 90 degrees, relative to the at least one main bristle of the at least one bristle including portion.

Furthermore, the at least one bristle including portion is substantially hollow such that it is capable of housing an oral agent.

In the present invention, the at least one bristle-containing portion is capable of housing at least one oral agent that is ingestible. The at least one oral agent can be, but is not limited to, for example toothpaste, enzymatic oral care solutions, oral sprays, oral gels, or a combination thereof.

In another embodiment, the at least one bristle including portion is at least in part prefilled, refillable, or a combination thereof with at least one oral agent.

In the present invention, the at least one bristle including portion can be at least in part prefilled, refillable, or a combination thereof with at least one oral agent for the purposes of fighting or preventing cavities, gingivitis, freshening breath, delivering medication, or a combination thereof.

III. An Edible or Substantially Edible Oral Care Device for Cleaning a Human or Non-Human Subject's Teeth

The present invention includes an edible or substantially edible oral care device for cleaning a human or non-human subject's teeth, including: a) at least one body portion; and b) at least one bristle including portion; wherein the at least one body portion and the at least one bristle portion are operably engaged to provide physical contact of the oral care device to the interior surfaces of a human or non-human subjects oral cavity when in use; wherein the oral care device is edible or substantially edible in whole or in part.

In addition, the at least one bristle including portion includes a plurality of flexibly resilient bristles extending radially outward from the bristle including portion and covering all or substantially all surfaces of the bristle including portion.

In the present invention, the at least one bristle including portion can include a plurality of flexibly resilient bristles can have a bristle density as is known in the art. Preferably, the bristle density is between about 1 and about 500 bristles per square millimeter, more preferably between about 2 and about 400, more preferable between about 3 and 300, more preferably between about 4 and 200, more preferably between about 5 and 100, more preferably between about 6 and 90. In a preferred embodiment, the at least one bristle including portion includes a plurality of flexibly resilient bristles can have a bristle density between about 4 and about 30 bristles per square millimeter. More preferably, the at least one bristle including portion includes a plurality of flexibly resilient bristles can have a bristle density such as toothbrushes or other brushes as known in the art for density of bristles.

In the present invention at least one bristle of the at least one bristle including portion can be thin, thick, can have a diameter as is known in the art, or a combination thereof, in at least one portion of at least one bristle of the at least one bristle including portion. Preferably, the diameter of the at least one bristle of the at least one bristle including portion is about 1 and about 50 millimeters, more preferably about 2 and about 45, more preferably about 3 and about 40, more preferably about 4 and about 35. In a preferred embodiment, the diameter of the at least one bristle of the at least one bristle including portion can be about 10 and about 30 millimeters.

Furthermore, at least one bristle of said bristle including portion includes at least one main bristle and at least one terminating end portion.

In the present invention at least one bristle of the at least one bristle including portion can be flat, narrow, rounded, polygonal, flat and wide, or a combination thereof, in at least one portion of at least one bristle of the at least one bristle including portion. Preferably, the shape of the at least one bristle of the at least one bristle including portion is at least in part flat and wide, like the shape of a wiper-blade.

In the present invention at least one bristle of the at least one bristle including portion can be relatively as to each other and as known in the art short in length, of medium length, long in length, or a combination thereof in at least one portion of at least one bristle of the at least one bristle including portion. All or substantially all of the bristles can be of the substantially the same, same or similar length. Preferably, the length of the at least one bristle of the at least one bristle including portion has a length of about 1 and about 100 millimeters, more preferably about 2 and about 90 millimeters, more preferably about 3 and about 80 millimeters, more preferably about 4 and about 70 millimeters, more preferably 5 and about 60 millimeters, more preferably 7 and about 50 millimeters. In a preferred embodiment, the length of the at least one bristle of the at least one bristle including portion is about 20 and about 50 millimeters in length. More preferably, the length of the at least one bristle of the at least one bristle including portion is about 25 and about 35 millimeters in length.

In another embodiment, the at least one terminating end portion is angled transverse, perpendicular or at varying angles to the main bristle.

In addition, the at least one terminating end portion of at least one bristle is substantially perpendicular to the main bristle.

In the present invention, the at least one main bristle of the at least one bristle including portion can be inserted at a minimum angle of about 1 and about 180 degrees, relative to its insertion plane, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one main bristle of the at least one bristle including portion can be inserted at an angle between about 45 and about 90 degrees.

In the present invention, the at least one terminating end portion of the at least one bristle including portion can have a minimum angle of about 1 and about 180 degrees, relative to the at least one main bristle of the at least one bristle including portion, more preferably between about 10 and about 170 degrees, more preferably about 20 and about 160 degrees, more preferably about 30 and about 150 degrees, more preferably about 40 and about 140 degrees, more preferably about 50, and about 130 degrees. In a preferred embodiment, the at least one terminating end portion of the at least one bristle including portion can be inserted at an angle between about 45 and about 90 degrees, relative to the at least one main bristle of the at least one bristle including portion.

Furthermore, the at least one bristle including portion is substantially hollow such that it is capable of housing an oral agent.

In the present invention, the at least one bristle-containing portion is capable of housing at least one oral agent that is ingestible. The at least one oral agent can be, but is not limited to, for example toothpaste, enzymatic oral care solutions, oral sprays, oral gels, or a combination thereof.

In another embodiment, the at least one bristle including portion is at least in part prefilled, refillable, or a combination thereof, with at least one oral agent.

In the present invention, the at least one bristle including portion can be at least in part prefilled, refillable, or a combination thereof with at least one oral agent for the purposes of fighting or preventing cavities, gingivitis, freshening breath, delivering medication, or a combination thereof.

### Examples

In one embodiment, there is a toothbrush for a human or non-human subject, such as an animal, e.g. or i.e., a pet such as a dog or cat, which effectively cleans an animal's teeth by utilizing the animal's propensity to bite down on objects placed into their mouths.

Dogs and other canine and feline pets such as cats have a tendency to bite objects that are placed into their mouths. Embodiments of the present invention include toothbrushes with bristles positioned at a bristle portion, which extend radially outward in 360 degrees around the toothbrush. The toothbrush is configured to be inserted into the dog's mouth such that the dog will bite down on the bristle portion. The toothbrush may be used in conjunction with flavored toothpaste applied to the bristle portion to entice the animal to repeatedly bite down on the bristle portion. The bristles of the toothbrush may be configured to gently scrape and clean the surfaces of the dog's teeth as the dog repeatedly bites down on the bristle portion of the toothbrush. While human toothbrushes may have a collectively flat brushing surface to be rubbed back and forth against the surface of the teeth, embodiments of the present invention may be configured such that the tips of the bristles are bent at an angle, preferably 90 degrees, such that the bent tip gently scrapes and rubs against the surface of the dog's teeth as the dog bites down on the bristles.

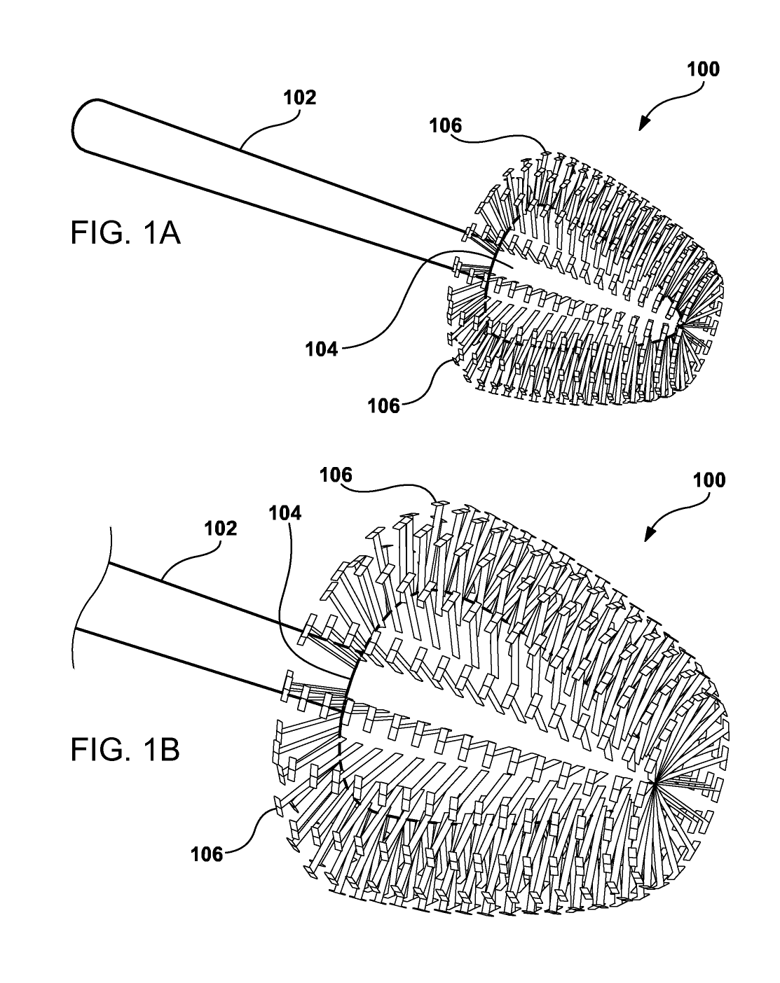

In an embodiment of the invention shown in FIG. 1A, there is an animal toothbrush with an elongated member (100) with a bristle portion (104) at a first end of the member and a handle portion (102) at a second opposite end of the member. The bristles (106) can be positioned tightly in relation to each other to create a dense, tightly packed bristle portion of the toothbrush. The bristle portion can be configured such that the brush includes bristles extending radially outward for 360 degrees around the bristle portion.

FIG. 1B depicts an elongated member (100) at a close up focusing on the bristle portion (104) to highlight one embodiment of the bristles (106) unique shape, which is described in detail in the present invention.

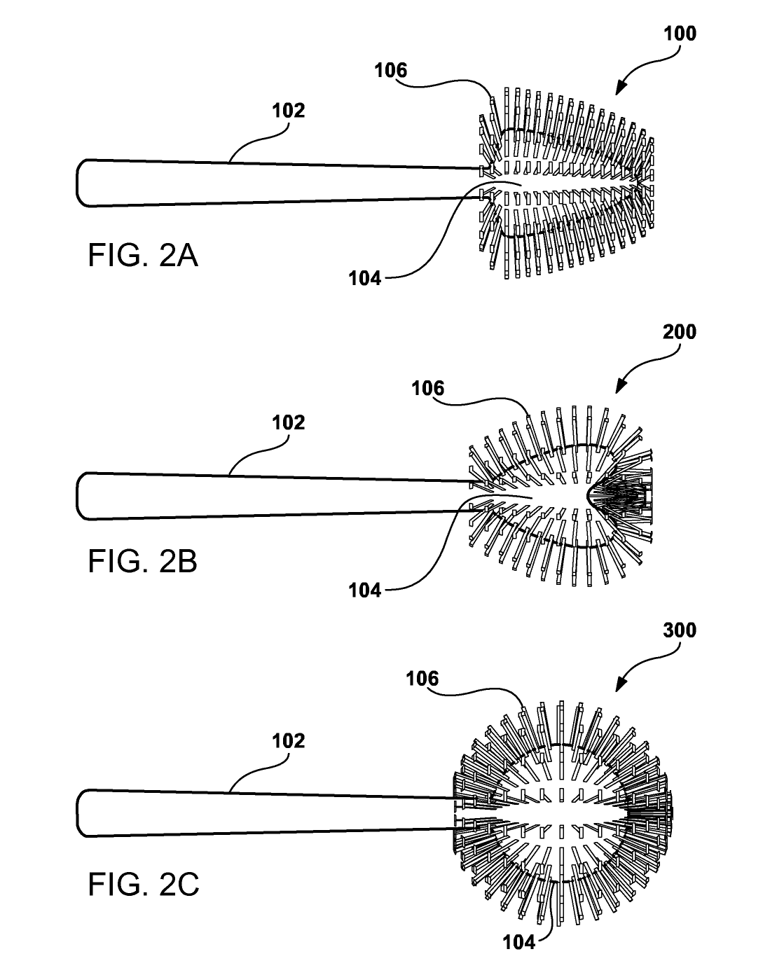

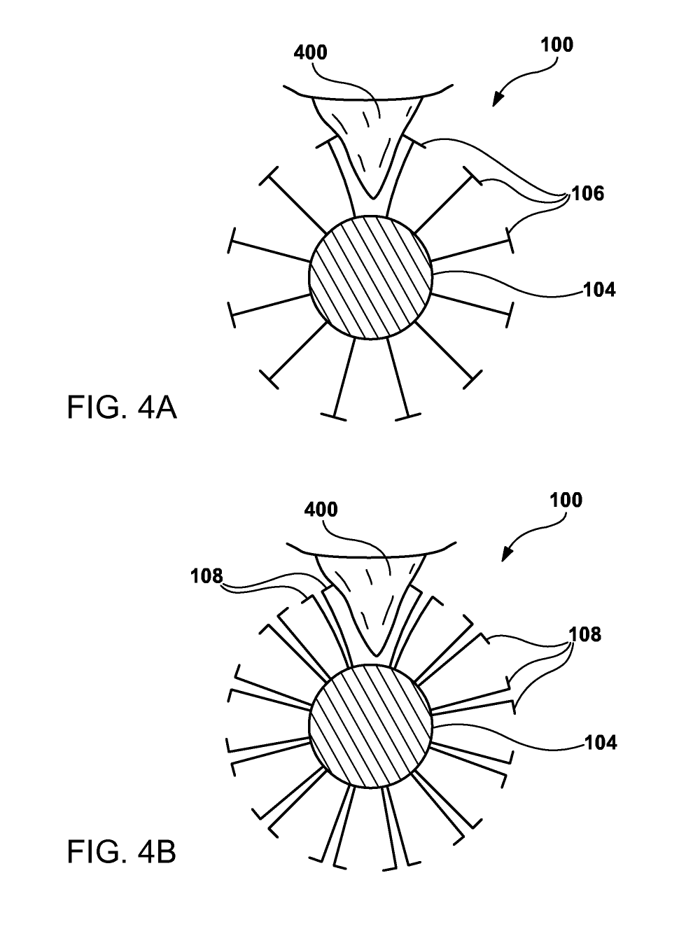

FIG. 2A, FIG. 2B, and FIG. 4C show alternate configurations and shapes of the bristle portion (104) of the present invention. In a preferred embodiment, the pet toothbrush can include a handle portion (102) and a replaceable bristle portion (104) such that the bristle portion can be removed and replaced with a new bristle portion once the bristles (106) have been worn down, or replaced with a same or different shaped bristle portion to customize the toothbrush for the animal. In other embodiments, the bristle portion can optionally not be replaceable and the handle and bristle portion can be formed of one unitary piece. In these embodiments, the user can optionally obtain different toothbrushes with the desired bristle portions (100, 200, and 300).

The bristle portions can vary in size, color, artificial flavoring applied to the bristles, bristle density, bristle material, bristle positioning, bristle stiffness, bristle shape (bent tips or T shaped bristles, L shaped bristles, etc.), and bristle portion shape, among other variables. FIG. 2A, FIG. 2B, and FIG. 2C show three different bristle portions. A user may need to switch between different toothbrushes with different bristle portions (100, 200, and 300), or switch between different bristle portions if the user owns multiple animals of varying sizes. The user may also need to switch between bristle portions to aid in cleaning certain parts of the animal's mouth.

The bristle portions can also vary in shape. Embodiments of the bristle portion can include various shapes, including but not limited to a cylinder shape, wedge shape (200), triangular shape (100), sphere shape (300), or disc shape. In certain preferred embodiments, the bristle portion includes a large number of bristles extending radially outward from the bristle portion in 360 degrees, but that need not be the case. FIG. 2B shows one embodiment of the bristle portion with a wedge or heart-shape (200) configured to clean the teeth of an animal with an elongated muzzle, such as a dog. The embodiment can be appropriately sized and configured such that the dog is enticed to bite down on the bristle portion with all of the dog's teeth making contact with the bristles (106) of the bristle portion (104) preferably each time the dog bites down on the bristle portion, but that need not be the case, and is a feature of other embodiments of the present invention.

FIG. 2C shows yet another embodiment of the bristle portion (104) with a sphere shape. This embodiment can mimic or approximate the shape and size of a toy ball that an animal such as a dog may be familiar with. In the same way that a dog may play with a toy ball by repeatedly biting down and chewing on the ball, the embodiment of FIG. 2C can be shaped and configured to entice the dog to repeatedly bite down on the bristle portion. Additionally, the embodiment of FIG. 2C can be sufficiently large enough to make contact with and clean multiple teeth of the dog upon each bite by the dog on the bristle portion.

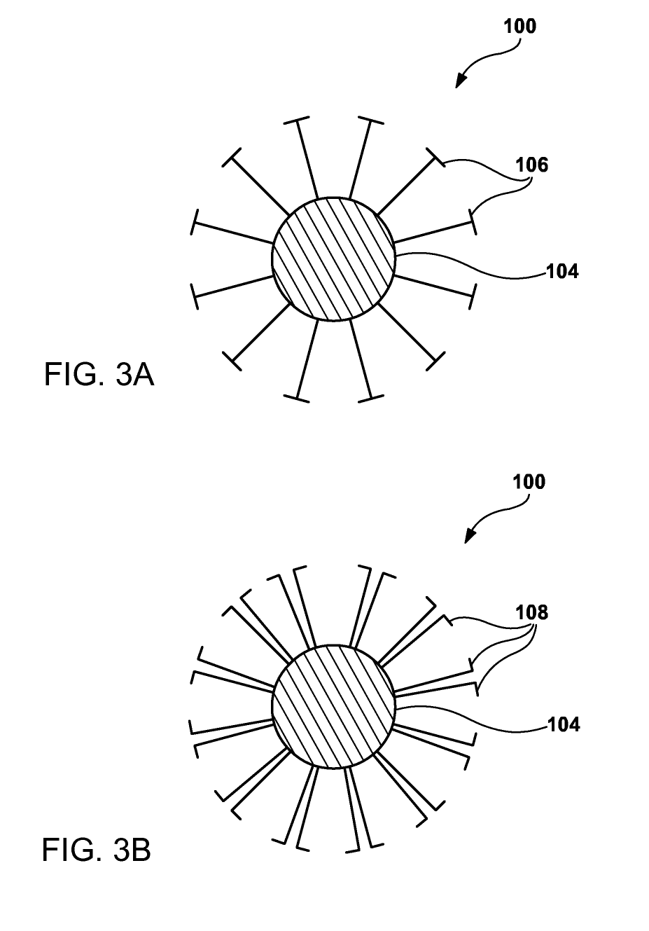

FIG. 3A shows a cross sectional view of the bristle portion (104) of an embodiment of the present invention. The tip of each bristle (106) can be bent in an angle (108) as is depicted in FIG. 3B, preferably at 90 degrees or about 90 degrees, but the angle may range between about 40 and about 120 degrees. The bristle portion may be arranged in rows of bristles. Each bristle in each row of bristles may be bent at the tip in the same perpendicular direction as the other bristles in the bristle row. In FIG. 3A, and FIG. 3B each bristle represents a row of bristles extending therebehind in substantially the same position and configuration. The bristle portion can include rows of bristles where the bent tips of successive bristle rows are positioned to face each (108) other such that the bent tips are touching, or just about touching or proximate to the bent tips of the next bristle row. In this configuration, the bristle rows are “paired” such that two consecutive bristle rows have bent bristle tips facing each other (108). In another configuration, the bristles can have bent tips and may have no arranged direction within a row of bristles. In this embodiment, the bent tips of the bristles can be bent in random and varying directions.

In another embodiment shown in FIG. 3A, bristles can be configured to have a “T” shape (106), such that each bristle includes two terminating ends, each end extending in opposite directions away from a main bristle shaft at an angle to the shaft of at 90 degrees, or about 90 degrees, most preferably.

While the angle of 90 degrees or substantially 90 degrees is preferred, it is noted it is preferable that the terminating ends at least extend transverse to the main shaft. For example, the angle of the terminating ends in relation to the main shaft may vary from between about 40 to about 120 degrees. The bristle can include, for example, two portions: a first main bristle portion extending radially outwardly from the toothbrush member, the main bristle portion connected at its terminating end to a second perpendicular bristle portion at substantially the middle point of the second perpendicular portion, such that the combined bristle has a substantially “T” shape. The toothbrush can include a large number of T shaped bristles, positioned to create a dense bristle portion such that when an animal bites down on the bristle portion, the second perpendicular bristle portions of the bristles can gently scrape and rub against the surfaces of the animal's teeth. The bristle portion can include arranged rows of the T shaped bristles such that each row of bristles is arranged parallel to the next bristle row. The bristle rows can be spaced such that the terminating ends of the perpendicular bristle portions of consecutive bristle rows can be just touching, or almost touching each other as shown in FIG. 3B. Other embodiments can include different shapes of bristles and terminating ends. Other shaped bristles can include helically shaped bristles, zig-zag shaped bristles, curly bristles, and various angular bristles. Preferred embodiments however preferably but not necessarily include at least one terminating end of the bristle which is transverse to the main bristle shaft where the terminating ends are configured to gently scrape and rub against the surfaces of the animal's teeth when the animal repeatedly bites down on the bristle portion of the toothbrush.

FIG. 4A and FIG. 4B are illustrations of an animal being cleaned by the bristles of the embodiments as discussed above in FIG. 3A and FIG. 3, respectively. In FIG. 4A, as the animal bites down on the bristle portion of the bristle portion (104), one or more of the animal's teeth (400) are forced in between the rows of bristles (106) such that the tooth forces the bristles to bend outward from the tooth (by a cramming or wedging action). The bristles are preferably made from a flexible material, which allows the bristles to bend, while sufficiently resilient and sufficiently rigid and stiff to apply a moderate amount of resistive backpressure against the surface of the tooth. As can be seen in FIG. 4A and FIG. 4B, the two rows of bristles on opposite sides of the tooth are forced apart as the tooth is forced between the rows. As the bristles apply resistive backpressure against the tooth, the bent tips of the two rows gently scrape and rub against the surface of the tooth, thereby cleaning the surface of the tooth and removing unwanted plaque and bacteria buildup.

As the animal releases its bite on the bristle portion of the toothbrush, the tooth is withdrawn from the rows of bristles. The bent tips remain flexibly resilient and apply resistive force against the tooth surface until the tooth is completely withdrawn. When the tooth has been completely withdrawn, the bristles return to their original position and shape, or substantially so. FIG. 4B is an illustration of a tooth (400) inserted into rows of bristles (108) of an embodiment with “L” shaped bristles. The cleaning process and interaction between the tooth and the bristles is substantially the same as the embodiment discussed in FIG. 4A. However, in the embodiment of FIG. 4B since the bristles include two terminating ends in opposite directions, the tooth can be cleaned regardless of which rows it is forced between.

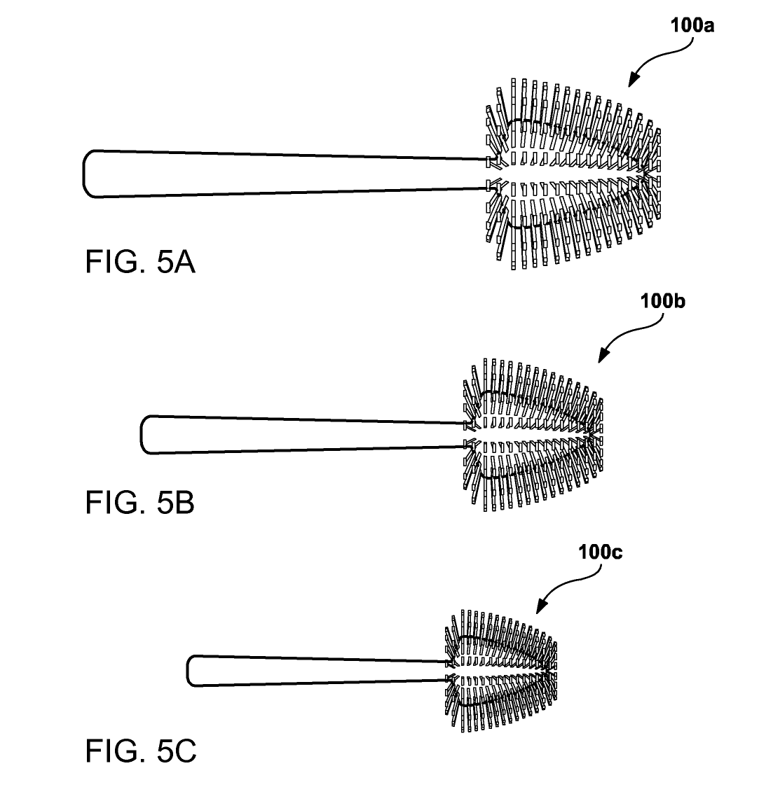

FIGS. 5A, 5B, and 5C are illustrations of the embodiments as discussed in FIG. 1A with varying sizes ranging from relatively large to relatively small. FIG. 5A is an embodiment of a relatively large sized animal toothbrush (100a) of the embodiment shown in FIG. 1A, which could be used for a larger animal. FIG. 5B is an embodiment of a relatively medium sized animal toothbrush (100b) of the embodiment shown in FIG. 1A, which could be used for medium to larger sized animals. FIG. 5C is an embodiment of a relatively small sized animal toothbrush (100e) of the embodiment shown in FIG. 1A, which could be used for a small to medium sized animal.

Not shown, but relating to FIG. 4A and FIG. 4B, the device can be used to clean the teeth of a pet animal with canine or feline teeth, such as a pet dog or cat. In this one embodiment, the bristles can have bent tips, and the bristle rows with the tips bent inwardly toward the outside surface of the dog's teeth or cat's teeth. It will be understood that an embodiment with T shaped bristles would be used in the same manner as shown in FIG. 4.

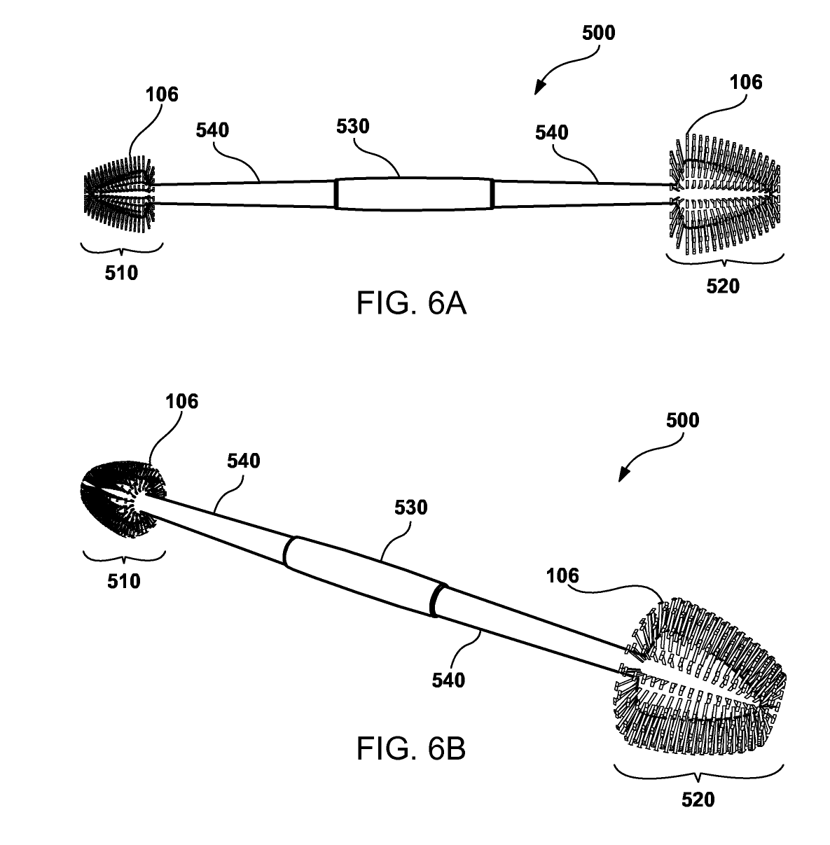

FIG. 6A and FIG. 6B are illustrations of an embodiment of the present invention (500). In the embodiment, a central handle for gripping the toothbrush is visible (530). The embodiment also includes two toothbrush heads (510) and (520) attached on either end of the elongated toothbrush member (540). The dual toothbrush heads (510) and (520) can be detachable as to central handle (530) and replaceable with alternate bristle head portions (510), (520), or both, to customize the brush to the user's needs. One side may be a larger brush (for a larger dog or larger teeth), and the other side may be a smaller brush (for a smaller dog or smaller teeth), but that need not be the case as the sizes and shapes can be the same or different for use on different subjects as different brush sizes and shapes can be used for the same or different subjects. In other embodiments, the bristle portions can be non-replaceable and can be formed of a single unitary piece with the handle portion of the toothbrush. The middle portion of the toothbrush, such as but not limited to (530) and (540), can also include other integrated tools necessary for cleaning an animal's teeth in place of a handle for the user.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

All publications, including patent documents and scientific articles, referred to in this application and the bibliography and attachments are incorporated by reference in their entirety for all purposes to the same extent as if each individual publication were individually incorporated by reference.

All headings are for the convenience of the reader and should not be used to limit the meaning of the text that follows the heading, unless so specified.

What is claimed is:

1. An oral care device for cleaning a human or non-human subject's teeth, comprising:
a. at least one body portion; and
b. at least one bristle including portion;
wherein said at least one body portion and at least one bristle including portion are operably engaged to provide physical contact of said oral care device to the interior surfaces of a human or non-human subject's oral cavity when in use.

2. The oral care device of claim 1,
wherein said at least one body allows an operator to grasp said at least one body and operably engage the interior surfaces of a human or non-human subject's oral cavity.

3. The oral care device of claim 1,
wherein said at least one bristle including portion comprises a plurality of flexibly resilient bristles extending radially outward from said bristle including portion and covering all or substantially all surfaces of said bristle including portion.

4. The oral care device of claim 1,
wherein at least one bristle of said bristle including portion comprises at least one main bristle and at least one terminating end portion.

5. The oral care device of claim 4,
wherein said at least one terminating end portion is angled transverse, perpendicular or at varying angles to said main bristle.

6. The oral care device of claim 4,
wherein said at least one terminating end portion of at least one bristle is substantially perpendicular to the main bristle.

7. The oral care device of claim 1,
wherein said at least one bristle including portion is substantially hollow such that it is capable of housing an oral agent.

8. The oral care device of claim 1,
wherein said at least one bristle including portion is at least in part prefilled, refillable, or a combination thereof, with at least one oral agent.

9. An oral care device for cleaning a human or non-human subject's teeth, comprising:
at least one bristle including portion;
wherein said at least one bristle portion is or is substantially the body of said oral care device.

10. The oral care device of claim 9,
wherein the said bristle including portion comprises a plurality of flexibly resilient bristles extending radially outward from said bristle including portion and covering all or substantially all surfaces of said bristle including portion.

11. The oral care device of claim 9,
wherein said at least one bristle of said bristle including portion comprises a main bristle and at least one terminating end portion.

12. The oral care device of claim 9,
wherein said at least one terminating end portion is angled transverse, perpendicular or at varying angles to said main bristle.

13. The oral care device of claim 9,
wherein said at least one terminating end portion of one or more bristles is substantially perpendicular to said main bristle.

14. The oral care device of claim 9,
wherein said at least one bristle including portion is substantially hollow such that it is capable of housing an oral agent.

15. The oral care device of claim 9,
wherein said at least one bristle including portion is at least in part prefilled, refillable, or a combination thereof with at least one oral agent.

16. An edible or substantially edible oral care device for cleaning a human or non-human subject's teeth, comprising:
a. at least one body portion; and
b. at least one bristle including portion;
wherein said at least one body portion and at least one bristle portion are operably engaged to provide physical contact of the said oral care device to the interior surfaces of a human or non-human subjects oral cavity when in use;
wherein said oral care device is edible or substantially edible in whole or in part.

17. The edible or substantially edible oral care device of claim 16,
wherein said at least one bristle including portion comprises a plurality of flexibly resilient bristles extending radially outward from said bristle including portion and covering all or substantially all surfaces of said bristle including portion.

18. The edible or substantially edible oral care device of claim 16,
wherein at least one bristle of said bristle including portion comprises at least one main bristle and at least one terminating end portion.

19. The edible or substantially edible oral care device of claim 16,
wherein said at least one terminating end portion is angled transverse, perpendicular or at varying angles to said main bristle.

20. The edible or substantially edible oral care device of claim 16,
wherein said at least one terminating end portion of at least one bristle is substantially perpendicular to the main bristle.

21. The edible or substantially edible oral care device of claim 16,
wherein said at least one bristle including portion is substantially hollow such that it is capable of housing an oral agent.

22. The edible or substantially edible oral care device of claim 16,
wherein said at least one bristle including portion is at least in part prefilled, refillable, or a combination thereof, with at least one oral agent.
